(19) United States
(12) Patent Application Publication
(10) Pub. No.: US 2017/0260942 A1
(43) Pub. Date: Sep. 14, 2017

(54) FUEL RETURN DEVICE

(71) Applicant: KABUSHIKI KAISHA TOYOTA JIDOSHOKKI, Kariya-shi (JP)

(72) Inventors: Kenichiro KAWAGUCHI, Aichi-ken (JP); Fumihiro SHIBAHARA, Aichi-ken (JP); Osamu SHIBUYA, Aichi-ken (JP); Nobuaki KAWABATA, Aichi-ken (JP)

(73) Assignee: KABUSHIKI KAISHA TOYOTA JIDOSHOKKI, Kariya-shi (JP)

(21) Appl. No.: 15/453,483

(22) Filed: Mar. 8, 2017

(30) Foreign Application Priority Data
Mar. 9, 2016 (JP) 2016-045181

(51) Int. Cl. F02M 37/00; B60K 15/01

(52) U.S. Cl. CPC F02M 37/0052; F02M 37/0023; F02M 37/0017; F02M 37/007; F02M 37/0082; B60K 15/01

(57) ABSTRACT

A fuel return device to be mounted to a fuel tank for returning an excess fuel flowing out from an engine through a fuel return piping member to the fuel tank includes a fuel return pipe connected to the fuel return piping member. The fuel return pipe has an opening that is opened to an upper space formed in the fuel tank with the fuel return pipe mounted to the fuel tank.

### BACKGROUND OF THE INVENTION

The present invention relates to a fuel return device mounted to a fuel tank of an internal combustion engine.

The following will describe an example of conventional fuel supply apparatus with reference to FIG. 12, which is a schematic view of the conventional fuel supply apparatus disclosed in Japanese Patent Application Publication 2003-83195. Referring to FIG. 12, the fuel supply apparatus which is designated by numeral 100 includes a fuel pump 102 and a filter device 104 that are mounted to a cover 106. The cover 106 is mounted on a fuel tank 108 so as to close an opening 110 that is formed through the bottom wall of the fuel tank 108. Two connecting members 112, 114 are mounted on the cover 106. A fuel filter 116 is attached to the inlet of the fuel pump 102 and the filter device 104 is connected to the outlet of the fuel pump 102 via a connecting pipe 118. The outlet of the filter device 104 is connected to the connecting member 112 to which a fuel feed pipe 122 is connected. A fuel outflow prevention valve 120 is disposed between the filter device 104 and the connecting member 112. A fuel return pipe 124 is connected to the connecting member 114 which is in turn connected to an extension pipe 128. A fuel outflow prevention valve 126 is disposed between the connecting member 114 and the extension pipe 128. The connecting member 114, the fuel return pipe 124, the fuel outflow prevention valve 126 and the extension pipe 128 cooperate to form a fuel return device 130.

In operation of the fuel pump 102, fuel pumped out by the fuel pump 102 is supplied to an engine (not shown) through the filter device 104, the fuel outflow prevention valve 120 and the fuel feed pipe 122. Excess fuel from the engine is returned to the fuel tank 108 through the fuel return pipe 124, the fuel outflow prevention valve 126 and the extension pipe 128. When the fuel pump 102 is stopped, the fuel outflow prevention valves 120, 126 are closed. If the fuel feed pipe 122 is removed while the fuel outflow prevention valves 120, 126 are closed, the fuel in the fuel tank 108 does not continue to flow out though the connecting member 112. The fuel in the fuel tank 108 does not keep flowing out through the connecting member 114 if the fuel return pipe 124 is removed from the fuel return device 130.

According to the above-described conventional fuel return device 130, however, the fuel outflow prevention valve 126 need to be provided in the fuel return device 130 in order to prevent the fuel from flowing out from the fuel tank 108 when the fuel return pipe 124 is removed, so that cost of the fuel return device is increased.

The present invention, which has been made in light of the above-problem, is directed to providing a fuel return device that permits omitting a fuel outflow prevention valve and reducing the cost of the fuel return device.

### SUMMARY OF THE INVENTION

In accordance with an aspect of the present invention, there is provided a fuel return device to be mounted to a fuel tank for returning an excess fuel flowing out from an engine through a fuel return piping member to the fuel tank. The fuel return device includes a fuel return pipe connected to the fuel return piping member. The fuel return pipe has an opening that is opened to an upper space formed in the fuel tank with the fuel return pipe mounted to the fuel tank.

### BRIEF DESCRIPTION OF THE DRAWINGS

FIG. 1 is a schematic view of a fuel supply apparatus including a fuel return device according to a first embodiment of the present invention;

FIG. 2 is a fragmentary front view of a fuel return pipe of the fuel return device of FIG. 1;

FIG. 3 is an exploded front view of the fuel return pipe of FIG. 2 in a disassembled state;

FIG. 4 is an exploded cross-sectional side view of the fuel return pipe of FIG. 3;

FIG. 5 is a fragmentary front view of a fuel return pipe of a fuel return device according to a second embodiment of the present invention;

FIG. 6 is an exploded front view of the fuel return pipe of the FIG. 5 in a disassembles state;

FIG. 7 is an exploded cross-sectional side view of the fuel return pipe of FIG. 6;

FIG. 8 is a schematic view of a fuel supply apparatus including a fuel return device according to a third embodiment of the present invention;

FIG. 9 is a schematic view of a fuel supply apparatus including a fuel return device according to a fourth embodiment of the present invention;

FIG. 10 is a fragmentary schematic sectional view of a fuel return pipe of a fuel return device according to a fifth embodiment of the present invention;

FIG. 11 is a fragmentary front view of a fuel return pipe and its associated parts of a fuel return device according to a sixth embodiment of the present invention; and

FIG. 12 is a schematic view of a conventional fuel supply apparatus.

### DETAILED DESCRIPTION OF THE EMBODIMENTS

The following will describe a fuel return device according to an embodiment of the present invention with reference to the accompanying drawings.

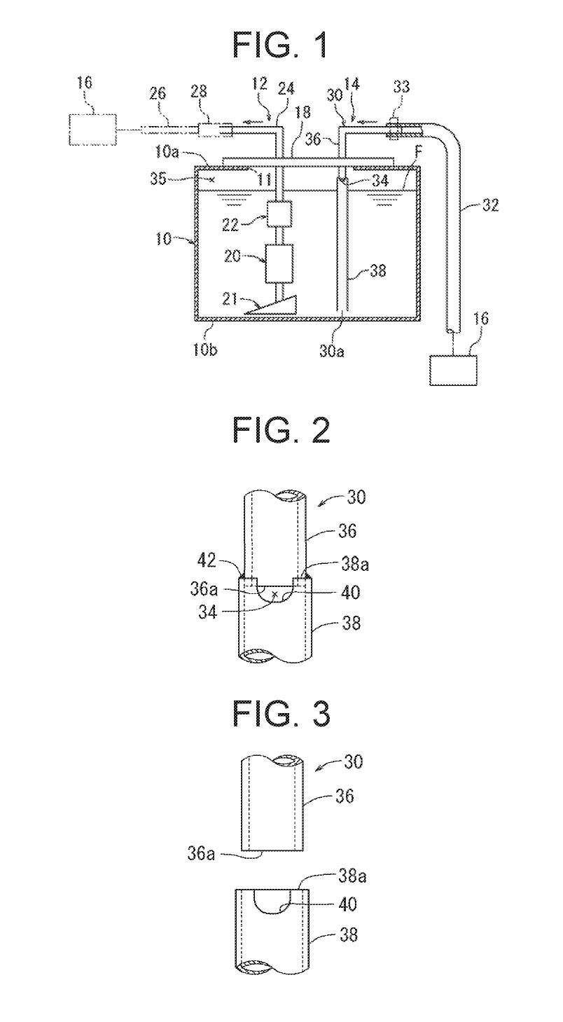

Referring to FIG. 1, there is shown a fuel supply apparatus 12 that includes a fuel return device 14 according to a first embodiment of the present invention. The fuel supply apparatus 12 is mounted to a fuel tank 10. In FIG. 1, the upper side and the lower side of the drawing correspond to the upper and lower sides in the gravity direction of the fuel tank 10. The fuel tank 10 is made of metal and mounted on an industrial vehicle provided with an engine 16, such as a fork lift truck. A liquid fuel is stored in the fuel tank 10.

The fuel supply apparatus 12, which is of a so-called top mounting type, is mounted on the fuel tank 10 and supplies fuel in the fuel tank 10 to the engine 16. The fuel tank 10 is made of a hollow metal container and includes an upper wall 10a and a bottom wall 10b. A circular opening 11 is formed through the upper wall 10a of the fuel tank 10. Although not shown in the illustration, the engine 16 includes a fuel distribution pipe for supplying fuel to each injector, a pressure regulator for adjusting the pressure of the fuel to be supplied to the injectors, and a filter device for filtering the fuel to be supplied to injectors. The filter device removes foreign object from fuel having passed through a fuel filter.

The fuel supply apparatus 12 further includes a cover 18, a fuel pump 20 and a fuel outflow prevention valve 22 that are supported by the cover 18 via a support member such as a bracket (not shown). The cover 18 is made of metal and mounted on the upper wall 10a of the fuel tank 10 so as to close the opening 11. The cover 18 forms a part of the upper wall 10a of the fuel tank 10.

A fuel feed pipe 24 is mounted to the cover 18 extending therethough vertically, and the upper end of the fuel feed pipe 24 is bent laterally. The fuel feed pipe 24 extends through the fuel outflow prevention valve 22 and the fuel pump 20 is connected to the lower end of the fuel feed pipe 24. The fuel outflow prevention valve 22 is formed by a check valve and operable to be opened by the flow of fuel in the fuel feeding direction and closed by the flow of fuel in the opposite direction. A fuel filter 21 is attached to the inlet end of the fuel pump 20. A fuel feed piping member 26, through which fuel is flowed to the engine 16, is connected to the upper end of the fuel feed pipe 24 via a fitting member 28 by screws. The fuel feed piping member 26 is provided by a high-pressure hose made of resin.

The fuel return device 14 will be now described. The fuel return device 14 includes a fuel return pipe 30 that is made of metal and supported by the cover 18. The fuel return pipe 30 extends vertically through the cover 18, and the upper end of the fuel return pipe 30 is bent laterally and connected to a fuel return piping member 32 through which excess fuel is returned from the engine 16. The fuel return piping member 32 is provided by a low-pressure hose made of rubber. The fuel return piping member 32 and the fuel return pipe 30 are connected together by a hose clip 33.

The fuel return pipe 30 extends towards the bottom of the fuel tank 10. The fuel return pipe 30 has at the lower end thereof an opening that serves as an exit 30a. The exit 30a is disposed adjacently to and spaced from the bottom wall 10b of the fuel tank 10 at a predetermined distance. The fuel return pipe 30 has an opening 34 through which the fuel return pipe 30 is opened to an upper space 35 that is formed in an upper part of the fuel tank 10. Specifically, the opening 34 is positioned at a level that is higher than the fuel surface F when the fuel tank 10 is fully filled.

The fuel return pipe 30 includes an upper pipe member 36 that is mounted to the cover 18 and a lower pipe member 38 that is connected to the upper pipe member 36. The upper pipe member 36 has a lower end surface 36a adjacent to the lower pipe member 38 and the lower pipe member 38 has an upper end surface 38a adjacent to the upper pipe member 36. The upper and lower pipe members 36, 38 are made of a circular metal pipe.

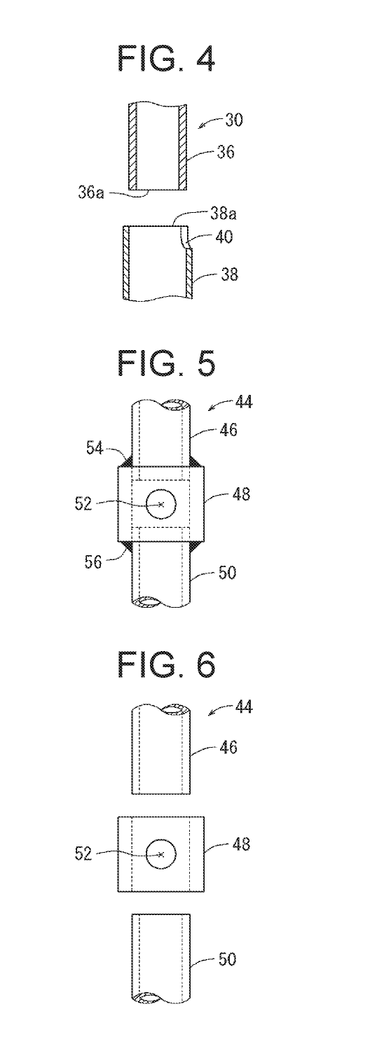

As shown in FIG. 2, the lower end of the upper pipe member 36 is formed to be inserted into the upper end of the lower pipe member 38. Specifically, the upper pipe member 36 has an outer diameter that is substantially the same as the inner diameter of the lower pipe member 38, as shown in FIGS. 3 and 4, In addition, the lower pipe member 38 has a U-shaped recessed portion 40 that is recessed from the upper end surface 38a of the lower pipe member 38.

With the lower end of the upper pipe member 36 inserted into the upper end of the lower pipe member 38, the upper and lower pipe members 36, 38 are joined by welding at a welding portion 42 in FIG. 2. Specifically, the upper pipe member 36 and the lower pipe member 38 are connected so that the opening 34 is formed in the fuel return pipe 30 by the recessed portion 40 of the lower pipe member 38 and the lower end surface 36a of the upper pipe member 36.

The following will describe the function of the fuel supply apparatus 12 with reference to FIG. 1. When the fuel pump 20 is started, fuel in the fuel tank 10 is filtered through the fuel filter 21 and drawn into the fuel pump 20. The fuel is pumped by the fuel pump 20 and flowed through the fuel outflow prevention valve 22 and the fuel feed pipe 24. The fuel is then supplied to the engine 16 through the fuel feed piping member 26. The pressure of the fuel to be supplied to the engine 16 is adjusted to a specific pressure by the pressure regulator. Excess fuel flowing out from an engine 16 is returned through the fuel return piping member 32 to the fuel tank 10.

According to the above-described fuel return device 14 in which the fuel return pipe 30 has the opening 34 through which the fuel return pipe 30 is opened to the upper space 35 in the fuel tank 10, the fuel in the fuel tank 10 is prevented from continuously flowing out from the fuel return pipe 30 by the siphon effect when the fuel return piping member 32 is removed from the fuel return pipe 30 or when any connecting parts such as a connector connected to the lower part of the fuel return piping member 32 are removed therefrom. Consequently, no fuel outflow prevention valve 126 used in the above-described conventional fuel return device (FIG. 12) in the above-cited publication need to be provided in the fuel return device 14 of the present embodiment, so that the cost of the fuel return device may be reduced.

Furthermore, the fuel return pipe 30 which is disposed extending towards the bottom of the fuel tank 10 allows excess fuel to be guided toward the bottom of the fuel tank 10 through the fuel return pipe 30, which prevents the excess fuel from splashing from the opening 34 of the fuel return pipe 30 against the fuel surface F in the fuel tank 10, so that bubbling of fuel and noise development on may be prevented.

The upper pipe member 36 and the lower pipe member 38 are connected so that the opening 34 is formed by the recessed portion 40 of the lower pipe member 38 and the lower end surface 36a of the upper pipe member 36. According to such connection of the upper pipe member 36 and the lower pipe member 38, metal chips produced by machining of the lower pipe member 38 to form the recessed portion 40 may be easily removed by cleaning. Consequently, the ingress of the metal chips into the fuel tank 10 may be prevented.

In addition, because the fuel return pipe 30 is mounted to the cover 18 of the fuel supply apparatus 12, mounting the fuel return pipe 30 to the fuel tank 10 may be accomplished by mounting the cover 18 to the fuel tank 10.

It is to be noted that the recessed portion 40 may be formed in the bottom end of the upper pipe member 36 so that an opening 34 is formed by the recessed portion in the upper pipe member 36 and the upper end surface 38a of the lower pipe member 38. In addition, the recessed portion 40 need not have a U-shape, but it may have any suitable shape, such as a square cut, a V-shape cut and a semicircular cut. The upper and lower pipe members 36, 38 may be provided by a square pipe.

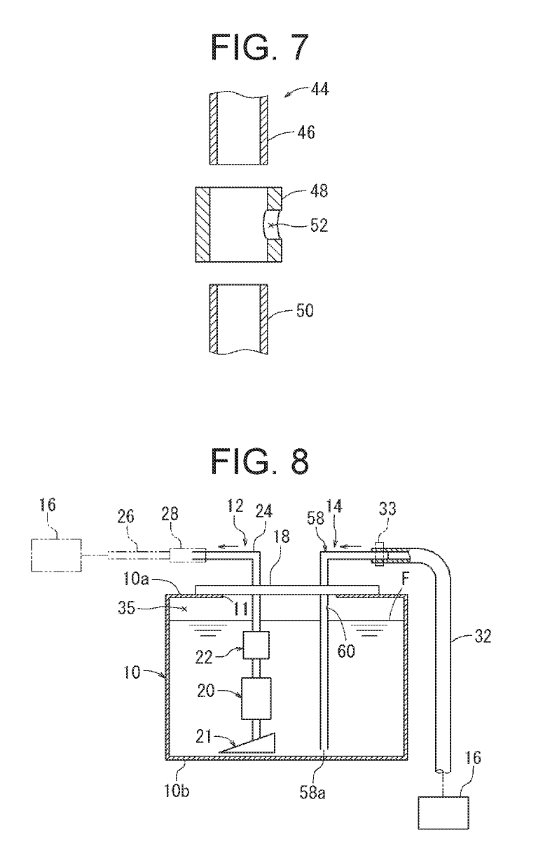

The following will describe a second embodiment of the present invention with reference to FIGS. 5 through 7. The second embodiment differs from the first embodiment in the structure of the fuel return pipe, Like parts or elements are designated by like reference numerals and the description thereof will not be reiterated. Referring to FIG. 5, there is shown a fuel return pipe 44 that includes an upper pipe member 46, a cylindrical connecting member 48 that is connected to the lower end of the upper pipe member 46 and a lower pipe member 50 that is connected to the lower end of the connecting member 48. The upper and lower pipe members 46, 50 are provided by a circular metal pipe. The connecting member 48 is made of metal and has a hollow cylindrical shape. As with the upper pipe member 36 of the first embodiment, the upper pipe member 46 is mounted to the cover 18,

As shown in FIG. 5, the lower end of the upper pipe member 46 is formed to be inserted into the upper end of the connecting member 48 and the upper end of the lower pipe member 50 is formed to be inserted into the lower end of the connecting member 48. Specifically, the upper and lower pipe members 46, 50 have an outer diameter that is substantially the same as the inner diameter of the connecting member 48. The connecting member 48 has at the center thereof a circular opening 52.

As shown in FIG. 5, with the lower end of the upper pipe member 46 inserted into the upper end of the connecting member 48, the upper pipe member 46 and the connecting member 48 are connected by welding at a welding portion 54. The lower pipe member 50 and the connecting member 48 are connected by welding at a welding portion 56. That is, the upper pipe member 46 and the lower pipe member 50 are connected through the connecting member 48.

According to the second embodiment, metal chips produced by machining of the connecting member 48 to form the opening 52 may be easily removed by cleaning. This prevents the ingress of metal chips into the fuel tank 10. The opening 52 need not have a circular hole shape, but may have any suitable shape such as a square shape and a semicircular shape,

The following will describe a third embodiment of the present invention with reference to FIG. 8. The third embodiment differs from the first embodiment in the structure of the fuel return pipe. Like parts or elements are designated by like reference numerals and the description thereof will not be reiterated. Referring to FIG. 8, there is shown a fuel return pipe 58 according to the third embodiment which is formed of a single circular pipe. As with the upper pipe member 36 of the first embodiment, the fuel return pipe 58 is mounted to the cover 18. A circular opening 60 is formed in the fuel return pipe 58 to be opened to the upper space 35 that is formed in an upper part of the fuel tank 10. In addition, the fuel return pipe 58 has at the lower end thereof an opening that serves as an exit 58a. The exit 58a of the fuel return pipe 58 is disposed adjacently to and spaced apart at a predetermined distance from the bottom wall 10b of the fuel tank 10.

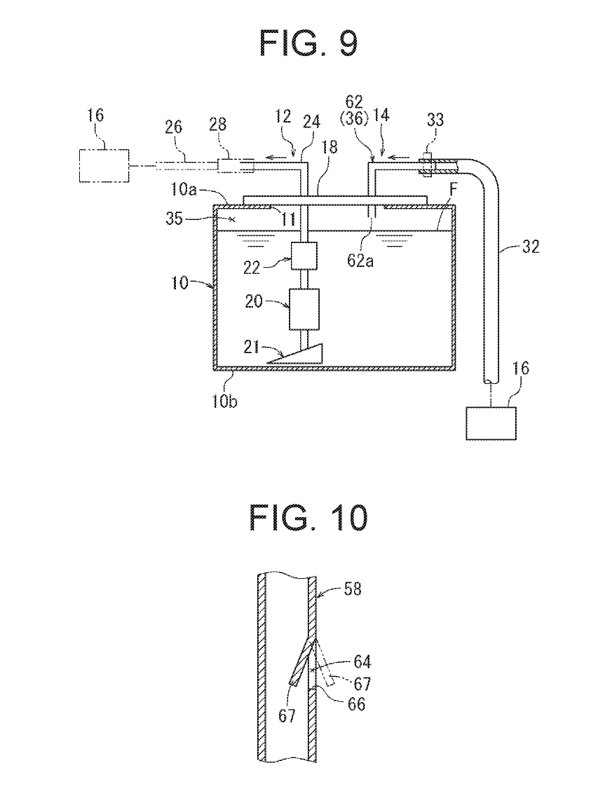

The following will describe a fourth embodiment of the present invention with reference to FIG. 9. Like parts or elements are designated by like reference numerals and the description thereof will not be reiterated. Referring to FIG. 9, there is shown a fuel return pipe 62 according to the fourth embodiment. The fuel return pipe 62 differs from the fuel return pipe 30 of the first embodiment in that the lower pipe member 38 of the fuel return pipe 30 is dispensed with and the fuel return pipe 62 is provided by a single pipe corresponding to the upper pipe member 36 of the first embodiment, The fuel return pipe 62 has an exit 62a that is opened to the upper space 35 of the fuel tank 10 and serves as the opening of the fuel return pipe 62.

The following will describe a fifth embodiment of the present invention with reference to FIG. 10. Like parts or elements are designated by like reference numerals and the description thereof will not be reiterated. Referring to FIG. 10, the fuel return pipe 58 of the fifth embodiment differs from the fuel return pipe 58 of the third embodiment in the shape of the opening. In the fuel return pipe 58 of the fifth embodiment, the opening 64 is formed by cutting and bending a part of the fuel return pipe 58. Specifically, a U-shaped cut 66 is made through the fuel return pipe 58 and a tongue-shaped cut section 67 is bent into the fuel return pipe 58 thereby forming the opening 64 through the fuel return pipe 58, as shown in FIG. 10.

Because no chip is produced by forming the cut 66 in the fuel return pipe 58, the ingress of cutting chips into the fuel tank 10 may be prevented. As indicated by double-dashed chain line 67 in FIG. 10, the opening 64 may be formed by bending the cut section 67 outwardly. The shape of the cut 66 need not necessarily be a U-shape, but may be any suitable shape such as a V-shape or a semicircular shape.

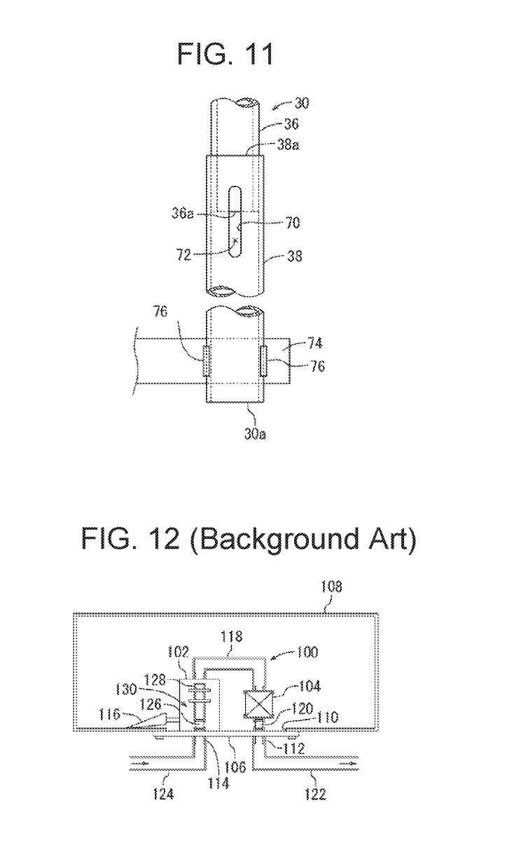

The following will describe a sixth embodiment of the present invention with reference to FIG. 11. Like parts or elements are designated by like reference numerals and the description thereof will not be reiterated. The fuel return pipe 30 of the sixth embodiment differs from that of the first embodiment in the shape of the opening. As shown in FIG. 11, the lower pipe member 38 according to the six embodiment has an elongated hole 70 extending in the up-down direction of the lower pipe member 38, instead of the recessed portion 40 according to the first embodiment. The upper pipe member 36 and the lower pipe member 38 are connected so that the elongated hole 70 and the lower end surface 36a cooperate to form an opening 72.

The fuel return device 14 of the sixth embodiment includes a support member 74 that is made of metal and has a band shape. Though not shown in FIG. 11, one end of the support member 74 (left in FIG. 11) is connected to the side wall of the fuel tank 10 by welding. The support member 74 is positioned at a location corresponding to the lower pipe member 38. The lower end of the lower pipe member 38 is connected to the support member 74 by welding at two positions, welding portions 76, on the opposite sides, that are left and right sides, of the lower pipe member 38, thus the lower pipe member 38 being supported by the fuel tank 10 through the support member 74. Unlike the first embodiment, the lower end of the upper pipe member 36 and the upper end of the lower pipe member 38 are not connected by welding.

It is to be noted that the entire elongated hole 70 may be used as the opening 72. In addition, the lower pipe member 38 may be connected to the support member 74 by one or three or more welding portions 76. The welding portions 76 may be formed at any suitable positions other than the lower end of the lower pipe member 38 at which the lower pipe member 38 is welded to the support member 74. The upper end of the lower pipe member 38 may be connected to the lower end of the upper pipe member 36 by welding. The support member 74 may be disposed on the bottom wall 10b of the fuel tank 10. The side wall of the fuel tank 10 may be used to support the lower pipe member 38 in place of the support member 74.

The present invention is not limited to the above-described embodiments, but may be modified in various manners within the scope of the present invention.

The use of the fuel return device 14 according to the present invention is not limited to an industrial vehicle, but the fuel return device 14 is applicable to any fuel tank for a gasoline or diesel engine used in a machine such as a motor vehicle, a motor bicycle, a vessel, a mower, an industrial machine and a mobile electricity generator.

A fuel return pipe may be made of resin.

The fuel return pipes 58, 62 and the upper pipe members 36, 46 need not necessarily be mounted to the cover 18 but may be mounted to the upper wall 10a or the side wall of the fuel tank 10. It may be so arranged that the fuel return pipes 58, 62 and the upper pipe members 36, 46 may be supported by the fuel tank 10.

In the second embodiment, it may so arranged that the lower pipe member 50 is supported by the fuel tank 10 as in the case of the lower pipe member 38 of the sixth embodiment. In this case, the connecting member 48 may be connected to at least one of the upper pipe member 46 and the lower pipe member 50 by welding, or may be supported by the fuel tank 10.

What is claimed is:

1. A fuel return device to be mounted to a fuel tank for returning an excess fuel flowing out from an engine through a fuel return piping member to the fuel tank, comprising:
a fuel return pipe connected to the fuel return piping member, the fuel return pipe having an opening that is opened to an upper space formed in the fuel tank with the fuel return pipe mounted to the fuel tank.

2. The fuel return device according to claim 1, wherein the fuel return pipe extends toward a bottom of the fuel tank.

3. The fuel return device according to claim 1, wherein the fuel return pipe includes an upper pipe member and a lower pipe member that is connected to the upper pipe member, wherein the upper pipe member has an end surface adjacent to the lower pipe member, wherein the lower pipe member has an end surface adjacent to the upper pipe member, wherein one of the upper pipe member and the lower pipe member has a recessed portion that is recessed from the end surface thereof, and wherein the opening is formed in the fuel return pipe by the recessed portion of the one of the upper pipe member and the lower pipe member and the end surface of the other of the upper pipe member and the lower pipe member.

4. The fuel return device according to claim 1, wherein the fuel return pipe includes an upper pipe member and a lower pipe member, wherein the upper pipe member and the lower pipe member are connected through a connecting member having the opening.

5. The fuel return device according to claim 1, wherein the fuel return pipe has an exit that serves as the opening of the fuel return pipe.

6. The fuel return device according to claim 1, wherein the opening is formed by cutting and bending a part of the fuel return pipe.

7. The fuel return device according to claim 1, wherein the fuel tank is provided with a fuel supply apparatus for supplying fuel in the fuel tank to the engine, the fuel supply apparatus comprising a cover closing an opening formed through an upper wall of the fuel tank; and wherein the fuel return pipe is mounted to the cover.
